(19) United States
(12) Patent Application Publication
(10) Pub. No.: US 2023/0153955 A1
(43) Pub. Date: May 18, 2023

(54) INFORMATION PROCESSING APPARATUS, INFORMATION PROCESSING METHOD, AND PROGRAM

(71) Applicant: SONY SEMICONDUCTOR SOLUTIONS CORPORATION, KANAGAWA (JP)

(72) Inventor: MUNETAKE EBIHARA, KANAGAWA (JP)

(21) Appl. No.: 17/919,667

(22) PCT Filed: Apr. 14, 2021
(86) PCT No.: PCT/JP2021/015463

§ 371 Date: Oct. 18, 2022

(30) Foreign Application Priority Data
Apr. 28, 2020 (JP) 2020-078965

(51) Int. Cl. G06T 5/00; G06T 3/40; G06T 5/50; G06T 7/12

(52) U.S. Cl. CPC G06T 5/002; G06T 3/4038; G06T 5/005; G06T 5/50; G06T 7/12; G06V 2201/07; G06T 2207/20221; G06T 2207/30201; G06T 2207/30242

(57) ABSTRACT

The present technology relates to an information processing apparatus, an information processing method, and a program that can, even in a case where a large number of abstraction targets such as persons' faces are included in an image to be processed such as a captured image, speedily and reliably abstract all the abstraction targets. Switching is made according to the number of abstraction targets that are included in a target image between a first process that individually abstracts image regions of the abstraction targets in the target image and a second process that abstracts the target image in whole, and the switched process 7performed. The present technology is applicable to an imaging apparatus and an image sensor.

### TECHNICAL FIELD

The present technology relates to an information processing apparatus, an information processing method, and a program and relates, in particular, to an information processing apparatus, an information processing method, and a program that can, even in a case where a large number of abstraction targets such as persons' faces are included in an image to be processed such as a captured image, speedily and reliably abstract all the abstraction targets.

### BACKGROUND ART

A technology that hides (abstracts) a predetermined subject in a captured image is disclosed in PTL 1.

### CITATION LIST

### Patent Literature

[PTL 1]

Japanese Patent Laid-Open No. 2019-092076

### SUMMARY

### Technical Problem

In a case where a large number of abstraction targets such as persons' faces are included in an image to be processed such as a captured image, it is difficult to speedily and reliably abstract all the abstraction targets due to an increased processing load.

The present technology has been devised in light of the above circumstances and can, even in a case where a large number of abstraction targets such as persons' faces are included in an image to be processed such as a captured image, speedily and reliably abstract all the abstraction targets.

### Solution to Problem

An information processing apparatus or a program of the present technology is an information processing apparatus that includes an image processing section or a program that causes such an information processing apparatus to function as a computer. The image processing section switches, according to the number of abstraction targets that are included in a target image, between a first process that individually abstracts image regions of the abstraction targets in the target image and a second process that abstracts the target image in whole and performs the switched process.

An information processing method of the present technology is an information processing method that switches, according to the number of abstraction targets that are included in a target image, between a first process that individually abstracts image regions of the abstraction targets in the target image and a second process that abstracts the target image in whole and performs the switched process.

In the present technology, switching is made according to the number of abstraction targets that are included in a target image between a first process that individually abstracts image regions of the abstraction targets in the target image and a second process that abstracts the target image in whole, and the switched process is performed.

### BRIEF DESCRIPTION OF DRAWINGS

FIG. 1 is a block diagram schematically illustrating an overall configuration of an imaging apparatus to which the present technology is applied.

FIG. 2 is a functional block diagram illustrating functions of a first embodiment of an image processing section as blocks.

FIG. 3 is a diagram illustrating, in simplified form, an example of a target image.

FIG. 4 is a diagram describing a privacy protection process performed on the target image in FIG. 3 in the first embodiment of the image processing section.

FIG. 5 is a diagram illustrating a target image obtained after subjecting the target image in FIG. 3 to the privacy protection process performed in the image processing section and is a diagram illustrating the target image obtained after a first masking process is performed in a masking process section.

FIG. 6 is a diagram illustrating, in simplified form, an example of a target image in a case where the number of masking targets is larger than a threshold for process switching.

FIG. 7 is a diagram describing the privacy protection process performed on the target image in FIG. 6 in the image processing section.

FIG. 8 is a diagram illustrating a target image obtained after subjecting the target image in FIG. 6 to the privacy protection process performed in the image processing section and is a diagram illustrating the target image obtained after a second masking process is performed in the masking process section.

FIG. 9 is a flowchart illustrating a processing procedure of the privacy protection process in the first embodiment of the image processing section.

FIG. 10 is a functional block diagram illustrating functions of a second embodiment of the image processing section as blocks.

FIG. 11 is a diagram illustrating, in simplified form, an example of a non-masking target image that is stored in a non-masking target storage section.

FIG. 12 is a diagram describing the privacy protection process performed on the target image in FIG. 3 in the second embodiment of the image processing section.

FIG. 13 is a diagram illustrating a target image obtained after subjecting the target image in FIG. 3 to the privacy protection process performed in the image processing section and is a diagram illustrating the target image obtained after a first masking process is performed in the masking process section.

FIG. 14 is a flowchart illustrating a processing procedure of the privacy protection process in the second embodiment of the image processing section.

FIG. 15 is a block diagram illustrating a hardware configuration example of a computer that performs a series of processes by a program.

### DESCRIPTION OF EMBODIMENTS

A description will be given below regarding embodiments of the present technology with reference to drawings.

### <<Imaging Apparatus 1 To Which Present Technology Is Applied>>

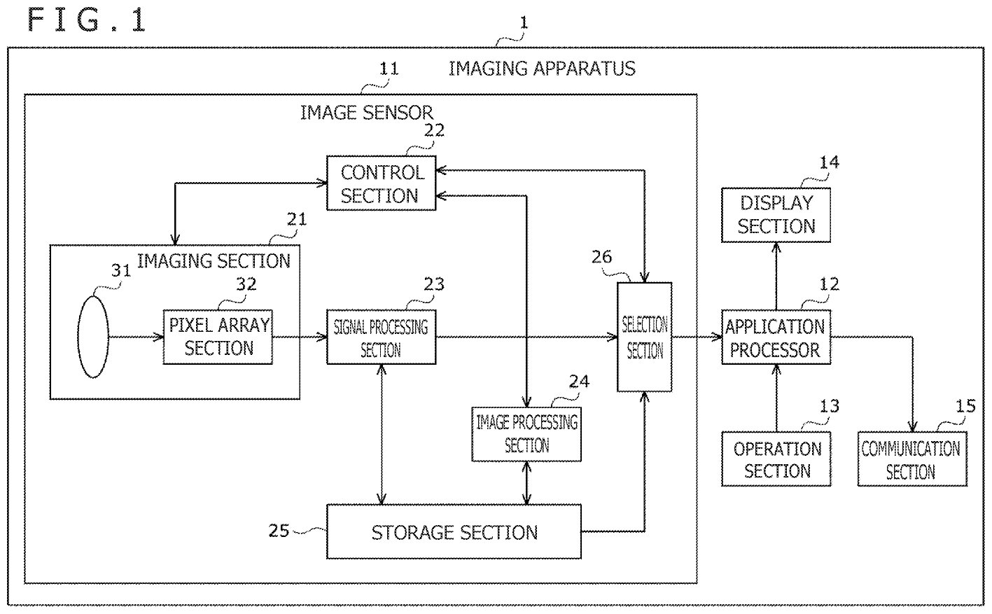

FIG. 1 is a block diagram schematically illustrating an overall configuration of an imaging apparatus 1 to which the present technology is applied.

The imaging apparatus 1 in FIG. 1 is an imaging apparatus used, for example, as a situation assessment camera and may be a surveillance camera, a digital camera, a digital video camera, a tablet terminal, a smartphone, or the like.

The imaging apparatus 1 is communicatably connected to an external apparatus such as server which is not illustrated. The external apparatus acquires an image captured by the imaging apparatus 1, stores the acquired image, performs a predetermined type of image customization on the acquired image, delivers the acquired image to other external apparatuses, or performs other tasks. It should be noted that the external apparatus may be an information processing apparatus used for any purposes. Also, the image captured by the imaging apparatus 1 may be a still image or a video.

The imaging apparatus 1 has an image sensor 11, an application processor 12, an operation section 13, a display section 14, and a communication section 15. It should be noted that there may be a case where the imaging apparatus 1 has neither the operation section 13 nor the display section 14 and the external apparatus communicatably connected to the imaging apparatus 1 does not function a function corresponding to the operation section 13 or the display section 14.

The image sensor 11 is a CMOS (Complementary Metal Oxide Semiconductor) image sensor that includes, for example, a single chip. The image sensor 11 receives incident light from a subject in a shooting range, converts the light into electricity, and acquires an image corresponding to the amount of incident light as an electric signal. Also, the image sensor 11 outputs an image obtained by subjecting the acquired image to a predetermined process to the application processor 12.

The application processor 12 is a CPU (Central Processing Unit) or any other processor that executes various applications. The application processor 12 performs various processes according to an application being executed. Also, the application processor 12 performs a process of detecting a user's operation on the basis of an operation signal from the operation section 13, a process of displaying an image from the image sensor 11 on the display section 14, and a process of sending the image or the like from the image sensor 11 to an external apparatus via the communication section 15.

The operation section 13 includes input apparatuses such as various switches and touch panels and supplies an operation signal that matches a user's operation of an input apparatus to the application processor 12.

The display section 14 includes a display apparatus such as a display and outputs an image supplied from the application processor 12.

The communication section 15 exchanges various pieces of information with external apparatuses through wired or wireless communication. For example, the communication section 15 communicatably connects to an external apparatus via any network such as a WAN (Wide Area Network) (including the Internet), a LAN (Local Area Network), a public switched telephone network, or a mobile communication network. Alternatively, the communication section 15 directly and communicatably connects to an external apparatus, for example, through a standard such as USB (Universal Serial Bus) or Bluetooth (registered trademark).

### (Configuration of Image Sensor 11)

The image sensor 11 has an imaging section 21, a control section 22, a signal processing section 23, an image processing section 24, a storage section 25, and a selection section 26.

The imaging section 21 receives incident light from a subject in a shooting range, converts the light into electricity, and acquires an image corresponding to the amount of incident light. The imaging section 21 includes an optical system 31 and a pixel array section 32.

The optical system 31 concentrates incident light that enters the optical system 31 from the subject in the shooting range and forms an image on a light-receiving surface of the pixel array section 32.

The pixel array section 32 includes unit pixels each of which includes a light-receiving element (photoelectric conversion section) and that are arranged in a two-dimensional matrix pattern. The pixel array section 32 converts incident light that enters each unit pixel into electricity and accumulates electric charge proportional to the amount of incident light.

The imaging section 21 reads out electric charge of each unit pixel accumulated in the pixel array section 32 and converts the electric charge from an analog signal into a digital signal by an AD converter which is not illustrated. The imaging section 21 supplies the converted digital signal to the signal processing section 23 as a signal representing the image captured by the imaging section 21.

It should be noted that the image captured by the imaging section 21 may, for example, be an RGB (red, green, blue) color image or a monochrome image having only luminance. Also, the imaging section 21 supplies a video to the signal processing section 23 by capturing images of the subject formed on the light-receiving surface of the pixel array section 32 at predetermined intervals and supplying the captured images to the signal processing section 23.

The control section 22 receives an instruction, an action mode, or the like based on a user's operation on the operation section 13 from the application processor 12. The control section 22 controls each section of the image sensor 11 according to the user's operation or action mode received from the application processor 12.

The signal processing section 23 performs various processes on the image supplied from the imaging section 21. For example, the signal processing section 23 performs noise removal, white balance adjustment, or other processes on the image from the imaging section 21. The signal processing section 23 temporarily stores the processed image in the storage section 25. Also, the signal processing section 23 supplies the processed image to the selection section 26.

The image processing section 24 reads out the image temporarily stored in the storage section 25 and processed in the signal processing section 23, as a target image to be subjected to a privacy protection process (hereinafter simply referred to as a target image). The image processing section 24 detects (recognizes) masking targets (abstraction targets) such as persons' faces included in the target image as the privacy protection process on the target image. Also, the image processing section 24 abstracts (hides), of the target image, image regions of the masking targets by a masking process (abstraction process). Then, the image processing section 24 temporarily stores, in the storage section 25, the target image obtained after the privacy protection process by which the image regions of the masking targets have been abstracted. It should be noted that the privacy protection process of the image processing section 24 will be described in detail later.

The storage section 25 temporarily stores the image processed in the signal processing section 23 (image that has yet to be subjected to the privacy protection process), the image that has been subjected to the privacy protection process in the image processing section 24, and the like. Also, the storage section 25 stores data to be used for the processes in the signal processing section 23, the image processing section 24, and the like.

The selection section 26 supplies the image from the signal processing section 23 or the image read out from the storage section 25 to the application processor 12 according to an instruction from the control section 22. In a normal mode where the privacy protection process is not performed, for example, the selection section 26 supplies the image from the signal processing section 23 to the application processor 12. Meanwhile, in a privacy protection mode (privacy masking mode) where the privacy protection process is performed, the selection section 26 reads out, from the storage section 25, the image that has been subjected to the privacy protection process by the image processing section 24 and stored in the storage section 25 and supplies the image to the application processor 12.

It should be noted that, in the privacy protection mode, the image supplied to the signal processing section 23 from the imaging section 21 may be supplied to the image processing section 24 from the signal processing section 23 without going through the storage section 25 and that the image that has been subjected to the privacy protection process by the image processing section 24 may be supplied to the selection section 26 from the image processing section 24 without going through the storage section 25. Also, even in a case where the image processing section 24 exchanges images with the signal processing section 23 and the selection section 26 via the storage section 25 as illustrated in FIG. 1, the image (still image or video) captured by the imaging section 21 is subjected to the privacy protection process by the image processing section 24 and output to the image sensor 11 without substantially any delay.

### <Details of First Embodiment of Image Processing Section 24>

A description will next be given regarding a first embodiment of the image processing section 24.

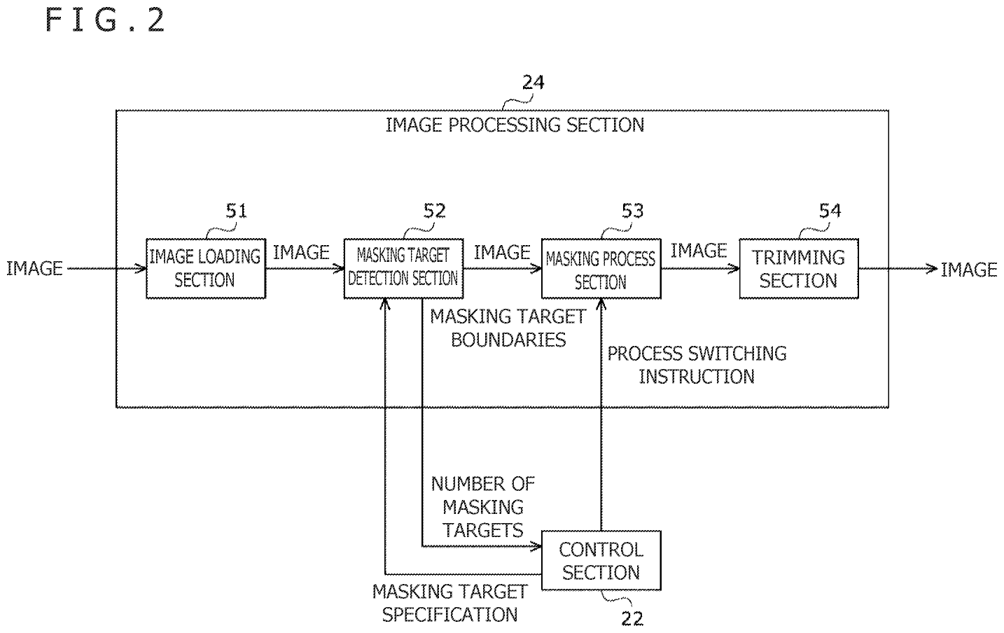

FIG. 2 is a functional block diagram illustrating functions of the first embodiment of the image processing section 24 as blocks.

In FIG. 2, the image processing section 24 has an image loading section 51, a masking target detection section (abstraction target detection section) 52, a masking process section 53, and a trimming section 54.

The image loading section 51 loads a target image to be subjected to the privacy protection process from the storage section 25 in FIG. 1 in the privacy protection mode. The image loading section 51 supplies the loaded target image to the masking target detection section 52.

The masking target detection section 52 detects (recognizes) masking targets (abstraction targets) such as persons' faces included in the target image from the image loading section 51. That is, the masking target detection section 52 detects image regions of the masking targets in the target image.

The masking targets are subjects or information to be hidden (abstracted) by the masking process (abstraction process). Types of masking targets that can be detected by the masking target detection section 52 include, for example, a person's face, a person's body, a person's posture, person's clothing, a character string, and the like. The character string is character information such as a license plate, a telephone number, first and last names, and the like, that are included in the target image.

As for the type of masking target to be detected by the masking target detection section 52, the user specifies one or multiple types among the types selectable such as a person's face, a person's body, a person's posture, person's clothing, and a character string by making a predetermined operation on the operation section 13 (see FIG. 1). The type of masking target specified by the user is given to the masking target detection section 52 from the control section 22 through masking target specification.

It should be noted that a case where the masking targets to be detected by the masking target detection section 52 are persons' faces will be described in the present first embodiment (and in a second embodiment described below), as an example. Also, an optional technique among known ones which uses a feature quantity extraction algorithm that detects image regions having feature quantities similar to those of the masking targets, template matching, machine learning model, or the like may be used for detecting the masking target such as a persons' face. The description of these techniques will be omitted.

When the masking target included in the target image is detected, the masking target detection section 52 sets image regions each having a predetermined shape including the image regions of the masking targets as masking target boundaries. Shapes of the masking target boundaries are each fixed to a predetermined shape and are each set, for example, to an elliptical shape in the present first embodiment (and in the second embodiment described below). It should be noted, however, that the masking target boundaries may each have a freely selected shape such as a rectangular shape, and the shapes of the masking target boundaries may be switched to one of multiple candidate shapes through a user's operation or the like.

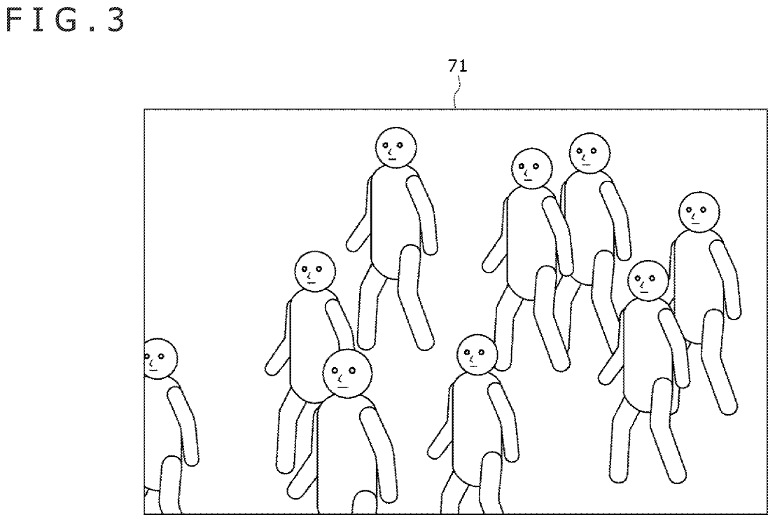

FIG. 3 is a diagram illustrating, in simplified form, an example of a target image.

In the example of a target image in FIG. 3, a target image 71 includes a plurality of persons' faces.

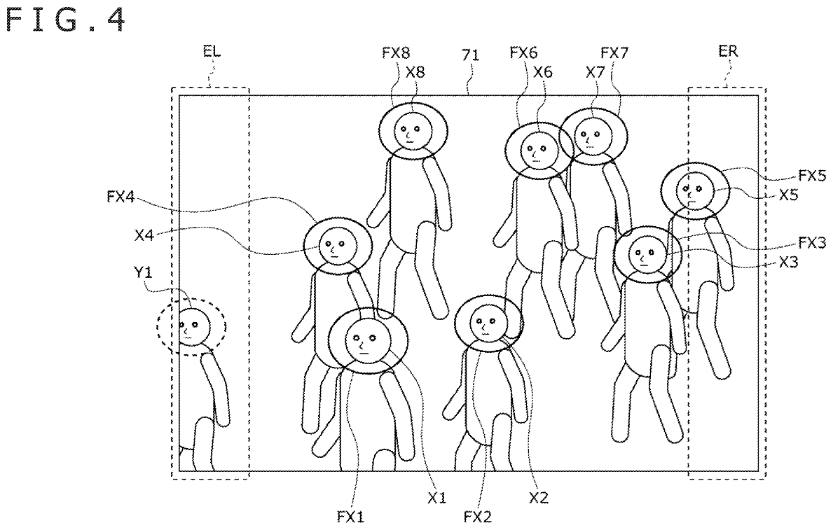

FIG. 4 is a diagram describing the privacy protection process performed on the target image 71 in FIG. 3 in the first embodiment of the image processing section 24.

In FIG. 4, a plurality of persons' faces X1 to X8 included in the target image 71 is detected by the masking target detection section 52 as masking targets. It is assumed that a person's face Y1 is not detected as a masking target because part thereof is outside the boundary of the target image 71.

Elliptical masking target boundaries FX1 to FX8 including the image regions of the persons' faces X1 to X8 detected as the masking targets are set for the respective image regions of the persons' faces X1 to X8.

In FIG. 2, the masking target detection section 52 supplies, to the masking process section 53, the target image from the image loading section 51 and information regarding the masking target boundaries set in the target image. Information regarding the masking target boundaries is information identifying positions, shapes, and sizes of the masking target boundaries in the target image.

Also, the masking target detection section 52 supplies the number of masking targets (masking target count) detected from the target image to the control section 22.

It should be noted that the masking target detection section 52 may not detect the image regions of the masking targets, and may detect the masking target boundaries including the image regions of the masking targets. In this case, it is not necessary to identify the image regions of the masking targets on a pixel-by-pixel basis, which makes it possible to reduce processing performance required of the masking target detection section 52 and speedily perform the processes of the masking target detection section 52 by using an inexpensive apparatus. It should be noted, however, that the masking target detection section 52 may detect the image regions of the masking targets and that the masking target boundaries may correspond to the image regions of the masking targets themselves (the boundaries of the image regions of the masking targets).

In FIG. 2, the masking process section 53 receives a process switching instruction from the control section 22. The masking process section 53 switches, in response to the process switching instruction from the control section 22, between a first process (hereinafter, a first masking process) that individually abstracts the image regions of the masking targets (masking target boundaries) in the target image and a second process (hereinafter, a second masking process) that abstracts the target image in whole and performs the switched process. The control section 22 gives a process switching instruction to the masking process section 53 to perform the first masking process in a case where the number of masking targets from the masking target detection section 52 is equal to or smaller than a predetermined threshold. Also, the control section 22 gives a process switching instruction to the masking process section 53 to perform the second masking process in a case where the number of masking targets (detected number) from the masking target detection section 52 is larger than the predetermined threshold. It should be noted that, in a case where the number of masking targets is 0, the control section 22 instructs the masking process section 53 to supply the target image from the image loading section 51 to the trimming section 54 in an as-is state.

It is assumed that the threshold (threshold for process switching) is, for example, 19 in the present first embodiment (second embodiment described below). In a case where the number of masking targets detected by the masking target detection section 52 is larger than 19, that is, equal to or larger than 20, the masking process section 53 performs the second masking process that abstracts the target image in whole, on the assumption that there is a possibility that a processing load on the masking target detection section 52 exceeds a processing performance limit for detecting the masking targets.

That is, the masking process section 53 switches between the first masking process and the second masking process according to the number of masking targets included in the target image and performs the switched process. The number of masking targets included in the target image corresponds to a magnitude of the processing load on the masking target detection section 52 (image processing section 24) required to detect all the target images included in the target image. If the number of masking targets included in the target image is larger than a predetermined number, a situation occurs in which the processing performance of the image processing section 24 is unable to deal with the processing load because the processing load exceeds its processing performance limit. Cases where the processing performance limit of the image processing section 24 is exceeded correspond, for example, to a case where time required to detect all the masking targets exceeds a time limit assigned to detection of the masking targets and a case where the number of masking targets included in the target image exceeds the maximum number of masking targets that can be detected by the masking target detection section 52, regardless of whether the time limit is exceeded.

In view of this, the threshold for process switching is set smaller than the number of masking targets included in the target image that causes the processing performance limit of the image processing section 24 to be reached. In other words, the threshold for process switching is set smaller than the number of masking targets (hereinafter, a limit count) that causes the processing load required for the image processing section 24 (masking target detection section 52) to detect the masking targets to reach the processing performance limit. At this time, in a case where the limit count is set to the threshold for process switching, the number of masking targets detected by the masking target detection section 52 is always the threshold for process switching, even when the number of masking targets included in the target image is larger than the threshold for process switching, which can result in a situation in which switching to the second masking process does not occur. Accordingly, the threshold for process switching is set smaller than the limit count.

As a result, in a case where the number of masking targets included in the target image is equal to or smaller than the threshold for process switching which is smaller than the limit count, that is, smaller than the limit count and equal to or smaller than the threshold, the masking process section 53 performs the first masking process. Also, in a case where the number of masking targets included in the target image is larger than the threshold for process switching which is smaller than the limit count, that is, at least equal to or larger than the limit count, the masking process section 53 performs the second masking process. In the present first embodiment (second embodiment described below), for example, the limit count is set to 20, and the threshold for process switching is set to 19 which is smaller only by 1 than the limit count.

It should be noted that the image processing section 24 (masking target detection section 52) may evaluate the magnitude of the processing load required to detect the masking targets by use of a detection value (e.g., processing time) other than the number of masking targets detected by the masking target detection section 52. In this case, for example, when the processing load required to detect the masking targets is equal to or smaller than a predetermined threshold, the masking process section 53 may perform the first masking process, and when the processing load required to detect the masking targets is larger than the predetermined threshold, the masking process section 53 may perform the second masking process.

In a case where the first masking process is performed, the masking process section 53 abstracts, of the target image, the images of the masking target boundaries set for the target image, on the basis of the target image and information regarding the masking target boundaries from the masking target detection section 52 by the masking process (abstraction process).

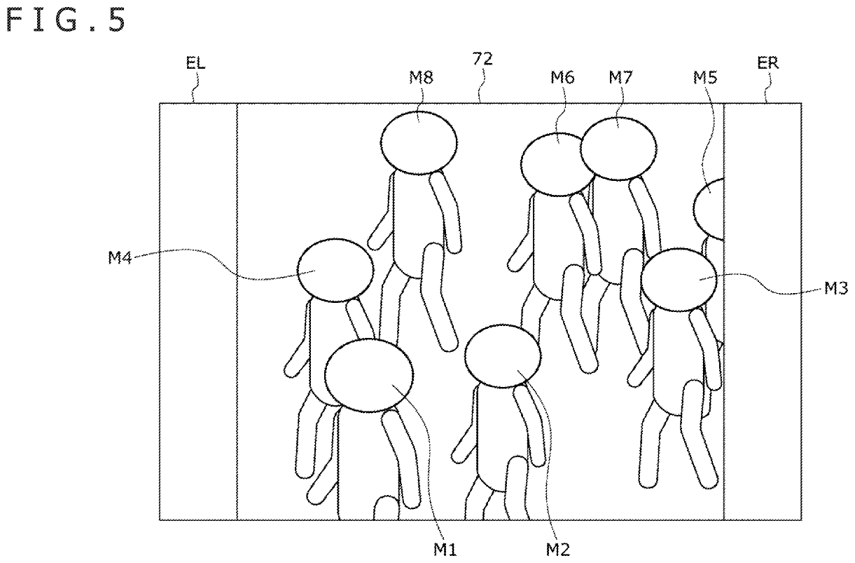

FIG. 5 is a diagram illustrating a target image obtained after subjecting the target image 71 in FIG. 3 to the privacy protection process performed in the first embodiment of the image processing section 24 and is a diagram illustrating the target image obtained after the first masking process is performed in the masking process section 53.

A target image 72 in FIG. 5 is an image obtained by subjecting the target image 71 in FIG. 3 to the privacy protection process in the image processing section 24. In the target image 71 in FIG. 3, the number of masking targets included in the target image 71 is 8 as illustrated in FIG. 4, and the threshold for process switching is equal to or smaller than 19. In this case, the masking process section 53 performs the first masking process and generates the target image 72 in FIG. 5.

In the target image 72 in FIG. 5, the images of the masking target boundaries FX1 to FX8 of the persons' faces X1 to X8 (see FIG. 3) set by the masking target detection section 52 are individually abstracted through superimposition of masking images M1 to M8 on the respective images by the masking process of the first masking process. This makes the persons' faces X1 to X8 unidentifiable and protects privacy of the persons' faces X1 to X8.

The masking images M1 to M8 in FIG. 5 illustrate a case where the masking target boundaries FX1 to FX8 are filled in a predetermined color by a filling process as a masking process. It should be noted, however, that the masking process in the first masking process may be a process other than the filling process such as a mosaicing process, a blurring process, a blending process, or a superimposition process of a fixed image and that any process may be performed as long as the images of the masking target boundaries are abstracted. In the mosaicing process, for example, the image within the masking target boundary is divided into a plurality of rectangular areas, and internal colors (luminances) in each area are averaged. In the blurring process, for example, each pixel of the image within the masking target boundary is replaced by an average value of surrounding colors (luminances). In the blending process, for example, the image within the masking target boundary is replaced by an image obtained by alpha-blending that image with any image such as a monochromatic image. In fixed image superimposition, for example, any predetermined fixed image is superimposed on the image within the masking target boundary.

In a case where the second masking process is performed, the masking process section 53 abstracts the target image in whole by the masking process (abstraction process).

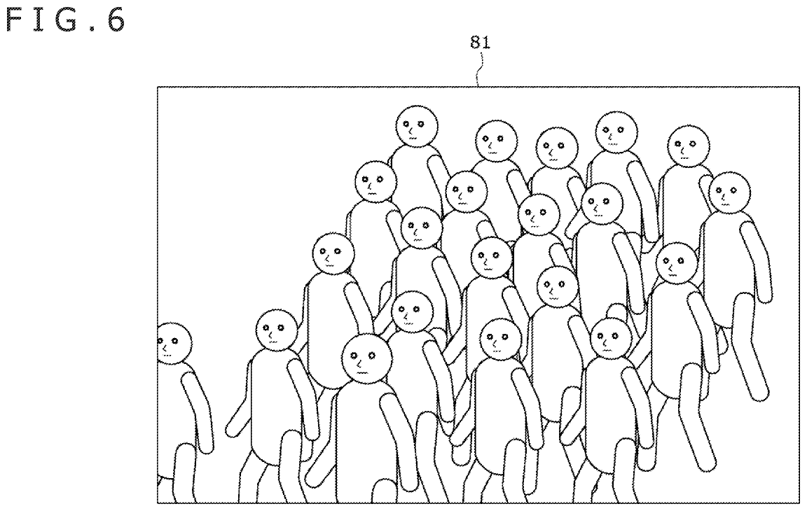

FIG. 6 is a diagram illustrating, in simplified form, an example of a target image in a case where the number of masking targets is larger than the threshold for process switching.

In the example of a target image 81 in FIG. 6, the target image 81 includes 20 or more persons' faces which exceed 19 which is the threshold for process switching.

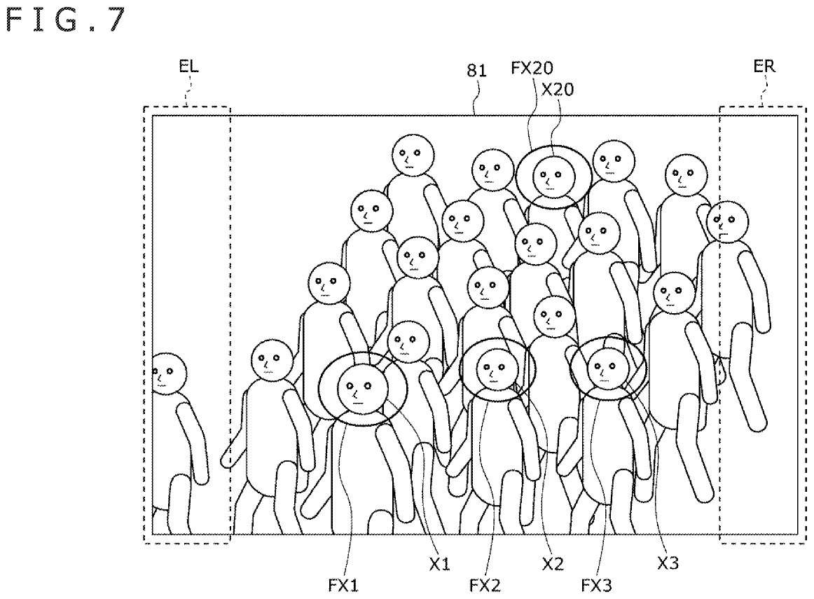

FIG. 7 is a diagram describing the privacy protection process performed on the target image 81 in FIG. 6 in the image processing section 24.

In FIG. 7, of the 20 or more persons' faces included in the target image 81, persons' faces X1 to X20 are detected by the masking target detection section 52 as masking targets. It should be noted that only the persons' faces X1 to X3 and X20 are illustrated by reference signs in FIG. 7. Because the number of masking targets detected by the masking target detection section 52 in this target image 81 is larger than 19 which is the threshold for process switching, the target image 81 in whole is abstracted by the second masking process performed by the masking process section 53. That is, it is difficult to detect the persons' faces included in the target image 81 with the processing performance of the masking target detection section 52, and it is difficult to individually abstract the image regions of all the persons' faces by the first process. Accordingly, the masking process section 53 abstracts the target image 81 in whole by the second process and protects privacy of all the persons.

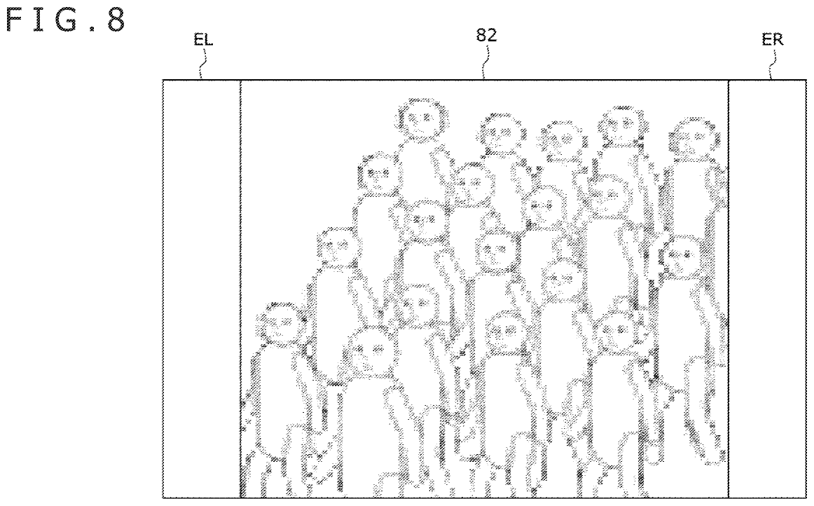

FIG. 8 is a diagram illustrating a target image obtained after subjecting the target image 81 in FIG. 6 to the privacy protection process performed in the image processing section 24 and is a diagram illustrating the target image obtained after the second masking process is performed in the masking process section 53.

A target image 82 in FIG. 8 is an image obtained by subjecting the target image 81 in FIG. 6 to the privacy protection process by the image processing section 24. The target image 82 in whole in FIG. 8 is abstracted by performing the mosaicing process on the target image 81 in FIG. 6 as a masking process in the second masking process.

The masking process in the second masking process may be a process other than the mosaicing process such as the blurring process, the blending process, the superimposition process of a fixed image, or the filling process and that any process may be performed as long as the target image in whole is abstracted.

The masking process section 53 supplies, to the trimming section 54 in FIG. 2, the target image that has been subjected to the masking process by means of the first masking process or the second masking process above.

The trimming section 54 in FIG. 2 cuts off a left edge region and a right edge region (image region) from the target image from the masking process section 53 by a trimming process. The trimming section 54 supplies, to the storage section 25 in FIG. 1, the target image obtained after the trimming process as a target image that has been subjected to the privacy protection process in the image processing section 24.

In the target image 71 in FIG. 4 loaded into the image loading section 51 in FIG. 1, for example, part of the person's face Y1 close to the left edge is outside the boundary of the target image 71. Accordingly, there is a possibility that the person's face Y1 may not be detected by the masking target detection section 52 as a masking target. Hence, there is a possibility that the image region of the person's face Y1 may not be abstracted by the first masking process of the masking process section 53. Meanwhile, there is a possibility that, even if the person's face Y1 is a partial image, the person may be identified.

Therefore, the trimming section 54 cuts off a left edge region EL and a right edge region ER from the target image 71 by the trimming process. In the target image 72 in FIG. 5 obtained after subjecting the privacy protection process to the target image 71 in FIG. 2, the images of the left edge region EL and the right edge region ER of the target image 71 have been cut off, and the image of the person's face Y1 has been excluded from the target image 72.

It should be noted that the images of the left edge region EL and the right edge region ER in the target image 81 in FIG. 6 have also been cut off, as illustrated in the target image 82 in FIG. 8 obtained after subjecting the target image 81 in FIG. 6 to the privacy protection process performed in the image processing section 24. It should be noted, however, that in a case where the target image in whole is abstracted by the second masking process performed by the masking process section 53, the trimming section 54 need not perform the trimming process on that target image.

Also, the trimming section 54 may cut off, by means of the trimming process, not the left edge and right edge regions, but the upper edge and lower edge regions of the target image from the masking process section 53. Alternatively, the trimming section 54 may cut off one or multiple regions, among the left edge region, the right edge region, the upper edge region, and the lower edge region in the target image, and the user may be able to select which region to cut off.

Also, the trimming section 54 may perform the masking process (abstraction process), instead of the trimming process, on the target image as a process corresponding to the trimming process.

Also, the trimming process (or masking process) by the trimming section 54 may not be performed on the target image to be subjected to the privacy protection process, and the image processing section 24 may not have the trimming section 54.

Also, the masking process section 53, the trimming section 54, or the like may add, to the target image obtained after the privacy protection process is carried out, information indicating that the target image has been subjected to the privacy protection process. For example, that information may be a logo, a character string, a license number, or the like indicating that the target image has been subjected to the privacy protection process. Also, information indicating that a privacy protection function is provided may be marked or displayed on an exterior of the apparatus to which the present technology is applied, a website of a server that provides services using the present technology, and the like.

All or some of the above processes of the image processing section 24 may be performed by a DSP (Digital Signal Processor) included in the image sensor 11. The DSP performs various processes by use of a learned machine learning model or the like by executing a program stored in the storage section 25, for example. A neural network, and particularly, a deep neural network (DNN) such as a CNN (Convolutional Neural Network) is used as a machine learning model, for example.

According to arithmetic processing of the DSP by use of a machine learning model, it is possible to perform a masking target detection process in the masking target detection section 52. For example, the positions and sizes of the image regions of the masking targets such as persons' faces included in the target image or the positions and sizes of the masking target boundaries having a predetermined shape including the image regions of the masking targets are calculated by the DSP as output data from the machine learning model by use of the target image to be subjected to the privacy protection process read out from the storage section 25 as input data to the machine learning model.

Also, according to arithmetic processing of the DSP, it is also possible to perform the processes of the masking process section 53 and the trimming section 54.

It should be noted that the processes of the masking target detection section 52 by means of a machine learning model by use of a neural network can be performed not only in a case where the DSP is used but also in other cases.

Also, some or all of the processes performed by components built into the image sensor 11 in FIG. 1 other than the imaging section 21 (the control section 22, the signal processing section 23, the image processing section 24, the storage section 25, and the selection section 26) can be performed, for example, by any information processing apparatus such as a server to which the imaging apparatus 1 is connected. Also, the target image to be subjected to the privacy protection process may not be an image directly supplied from a predetermined imaging apparatus. Also, a ToF (Time of Flight) sensor, a millimeter-wave radar, a LIDER (Light Detection And Ranging), or any other sensors may be used to detect the masking target.

### (Processing Procedure in First Embodiment of Image Processing Section 24)

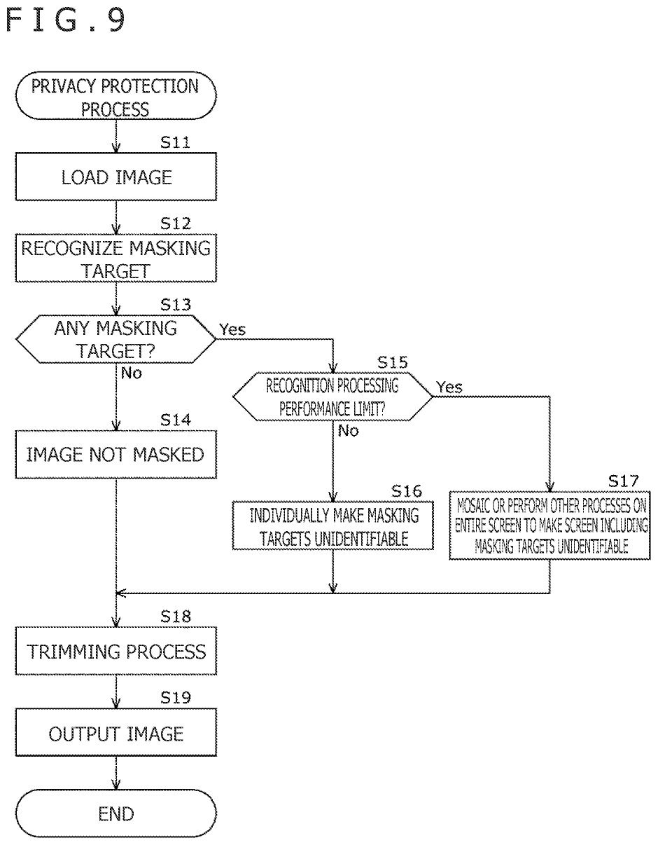

FIG. 9 is a flowchart illustrating a processing procedure of the privacy protection process in the first embodiment of the image processing section 24.

In step S11, the image processing section 24 (image loading section 51) loads a target image to be subjected to the privacy protection process from the storage section 25 (see FIG. 1). The process proceeds from step S11 to step S12.

In step S12, the image processing section 24 (masking target detection section 52) recognizes (detects) masking targets included in the target image loaded in step S11. The process proceeds from step S12 to step S13.

In step S13, the image processing section 24 (control section 22) determines whether or not there are any masking targets recognized in step S12 (whether the number of masking targets is 1 or more).

In a case where it is determined in step S13 that there are no recognized masking targets, the process proceeds to step S14, and the image processing section 24 (masking process section 53) does not perform the masking process on the target image. The process proceeds from step S14 to step S18.

In a case where it is determined in step S13 that there are recognized masking targets, the process proceeds to step S15, and the control section 22 determines whether or not the processing load for recognizing (detecting) the masking targets in step S12 has reached the processing performance limit (processing performance limit for recognition). Specifically, the control section 22 determines whether or not the number of masking targets (masking target count) recognized in step S12 is equal to or smaller than 19.

In a case where it is determined in step S15 that the processing performance limit for recognition has yet to be reached (in a case where the number of masking targets is equal to or smaller than 19), the process proceeds to step S16, and the image processing section 24 (masking process section 53) individually abstracts the masking targets (makes the masking targets unidentifiable) by the first masking process. The process proceeds from step S16 to step S18.

In a case where it is determined in step S15 that the processing performance limit for recognition has been reached (in a case where the number of masking targets is larger than 19), the process proceeds to step S17, and the image processing section 24 (masking process section 53) abstracts the target image in whole loaded in step S11 (makes the target image in whole unidentifiable) by the second masking process through the masking process such as the mosaicing process. The process proceeds from step S17 to step S18.

In step S18, the image processing section 24 (trimming section 54) cuts off, for example, the left edge or right edge region from the target image obtained in step S14, step S16, or step S17 by the trimming process. The process proceeds from step S18 to step S19.

In step S19, the image processing section 24 (trimming section 54) outputs, to the storage section 25 (FIG. 1), the target image obtained after the trimming process in step S18 as a target image obtained after the privacy protection process.

According to the above first embodiment of the image processing section 24, switching is made between the first masking process and the second masking process, according to the number of masking targets included in the target image, and the switched process is performed, which makes it possible to speedily and reliably abstract the masking targets, regardless of the number of masking targets. This allows privacy of even a real-time image (still image or video) from a live camera or the like to be protected without substantially any delay.

### <Details of Second Embodiment of Image Processing Section 24>

A description will next be given of the second embodiment of the image processing section 24 in FIG. 1.

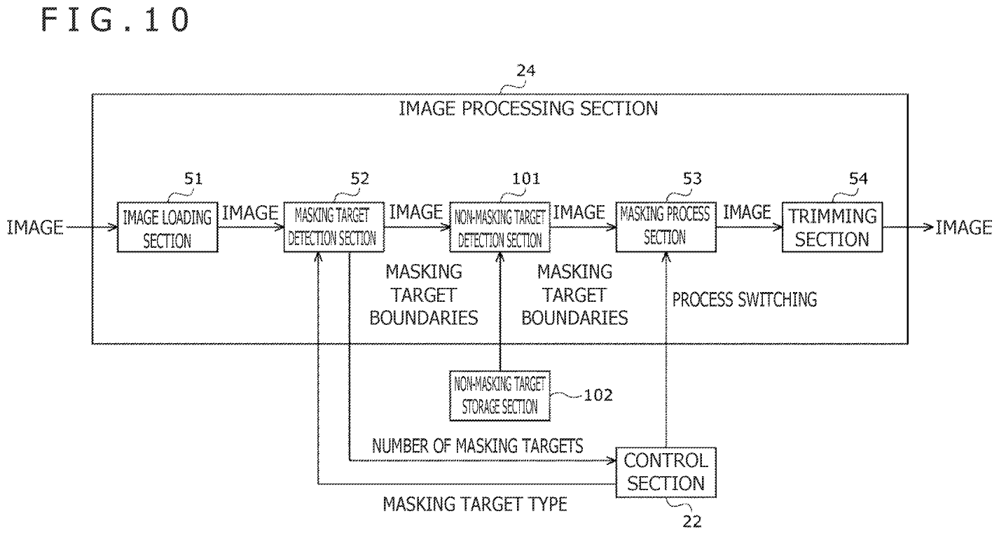

FIG. 10 is a functional block diagram illustrating functions of the second embodiment of the image processing section 24 as blocks. It should be noted that the same reference signs are assigned to portions in FIG. 10 corresponding to those of the image processing section 24 in FIG. 2 and that the description thereof will be omitted. Also, an aspect (e.g., an extension example or a modification example) that can be adopted in the first embodiment of the image processing section 24 can similarly be adopted in the present second embodiment, and the description thereof will be omitted.

The image processing section 24 in FIG. 10 has the image loading section 51, the masking target detection section 52, the masking process section 53, the trimming section 54, and a non-masking target detection section 101. In consequence, the image processing section 24 in FIG. 10 has a commonality with that in the case of FIG. 2 in that it has the image loading section 51, the masking target detection section 52, the masking process section 53, and the trimming section 54. It should be noted, however, that the image processing section 24 in FIG. 10 differs from that in the case of FIG. 2 in that the non-masking target detection section 101 is newly provided.

The non-masking target detection section 101 receives, from the masking target detection section 52, a target image loaded by the image loading section 51 and information regarding masking target boundaries set by the masking target detection section 52 in the target image.

Also, the non-masking target detection section 101 acquires a non-masking target (non-abstraction target) image from a non-masking target storage section 102. The non-masking target is, of the masking targets included in the target image, a masking target to be excluded from the target to be abstracted. For example, in a case where the masking targets are persons' faces, a specific person's face to be excluded from the target to be abstracted is a non-masking target.

The non-masking target storage section 102 illustrates the portion of the storage section 25 in FIG. 1 where information regarding the non-masking target is stored. The non-masking target storage section 102 stores a non-masking target image determined in advance. Also, the non-masking target storage section 102 stores one or multiple non-masking target images. Of the non-masking target images stored in the non-masking target storage section 102, for example, one or the plurality of non-masking target images specified by a user's operation as the non-masking targets are read out into the non-masking target detection section 101. For example, in addition to a specific person's face, specific clothing, a specific character string, and the like can be set as the non-masking targets.

It should be noted that a description will be given on the assumption that the masking targets are persons' faces also in the second embodiment and the non-masking target is a specific person's face.

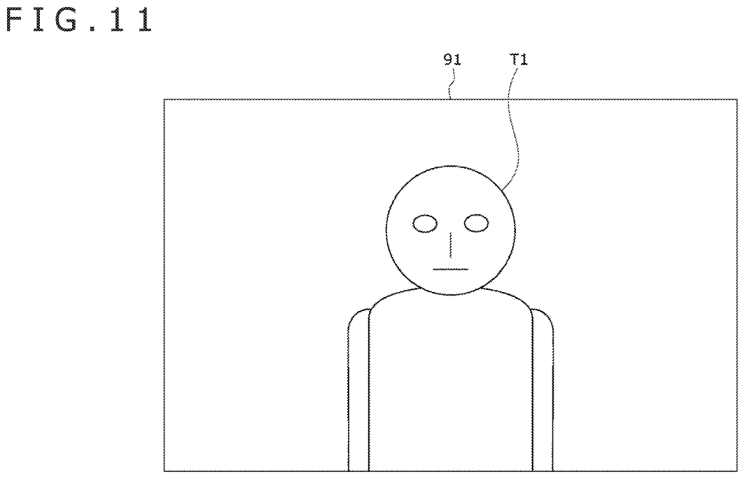

FIG. 11 is a diagram illustrating, in simplified form, an example of a non-masking target image that is stored in the non-masking target storage section 102.

A person's face T1 which is a non-masking target is seen in an image 91 in FIG. 11. Such an image 91 obtained by capturing the person's face T1 to be excluded from the making target is stored in advance in the non-masking target storage section 102.

The non-masking target detection section 101 detects (recognizes) the face of a specific person who is a non-masking target included in the target image, on the basis of the image of the face of a specific person who is a non-masking target acquired from the non-masking target storage section 102. That is, the non-masking target detection section 101 detects, of the target image, the image region of the face of the same person as that of the specific person who is the non-masking target. It should be noted that the non-masking target detection section 101 may detect, among the masking target boundaries set in the target image by the masking target detection section 52, the face of the same person as that of the specific person who is the non-masking target.

The non-masking target detection section 101 sets, of the masking target boundaries set by the masking target detection section 52, other masking target boundaries than the masking target boundary including the image region in which the face of the specific person who is the non-masking target has been detected, as new masking target boundaries. Then, the non-masking target detection section 101 supplies, to the masking process section 53, the target image from the masking target detection section 52 and information regarding the newly set masking target boundaries.

The masking process section 53 performs the masking process as in the first embodiment on the basis of the target image from the non-masking target detection section 101 and the newly set masking target boundaries.

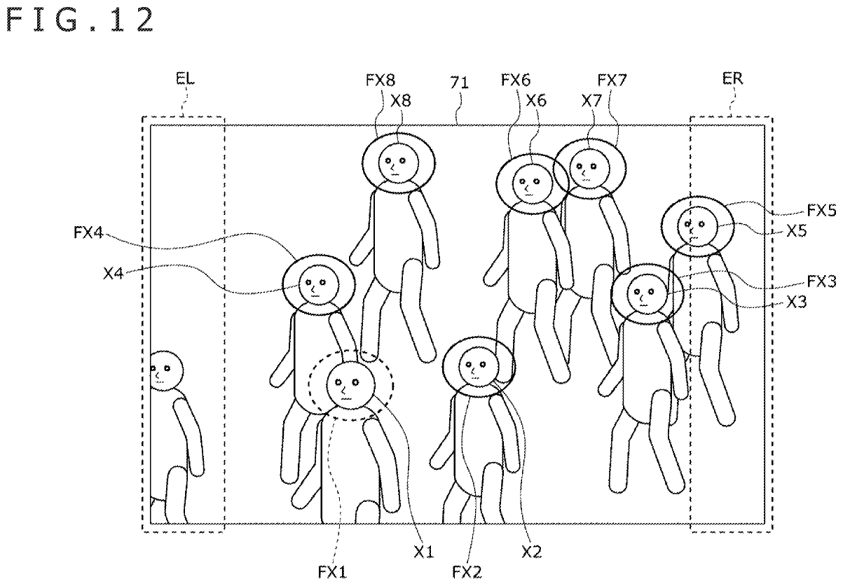

FIG. 12 is a diagram describing the privacy protection process performed on the target image 71 in FIG. 3 in the second embodiment of the image processing section 24. It should be noted that the same reference signs are assigned to the portions in FIG. 12 corresponding to those in FIG. 4 and that the description thereof will be omitted as appropriate.

In FIG. 12, the plurality of persons' faces X1 to X8 included in the target image 71 is detected by the masking target detection section 52 as the masking targets.

The elliptical masking target boundaries FX1 to FX8 including the image regions of the persons' faces X1 to X8 detected as the masking targets are set by the masking target detection section 52 for the respective image regions of the persons' faces X1 to X8.

It is assumed, for example, that the non-masking target detection section 101 detects (recognizes), of the persons' faces X1 to X8 detected by the masking target detection section 52, the person's face X1 as a person's face which is the non-masking target. At this time, the non-masking target detection section 101 newly sets, of the masking target boundaries FX1 to FX8, the masking target boundaries FX2 to FX8 except for the masking boundary FX1 as masking target boundaries and supplies information regarding the masking target boundaries FX2 to FX8 to the masking process section 53.

The masking process section 53 performs the masking process on the masking target boundaries FX2 to FX8 set as the masking target boundaries as in the first embodiment. Also, the trimming section 54 cuts off the left edge region EL and the right edge region ER from the target image 71 as in the first embodiment.

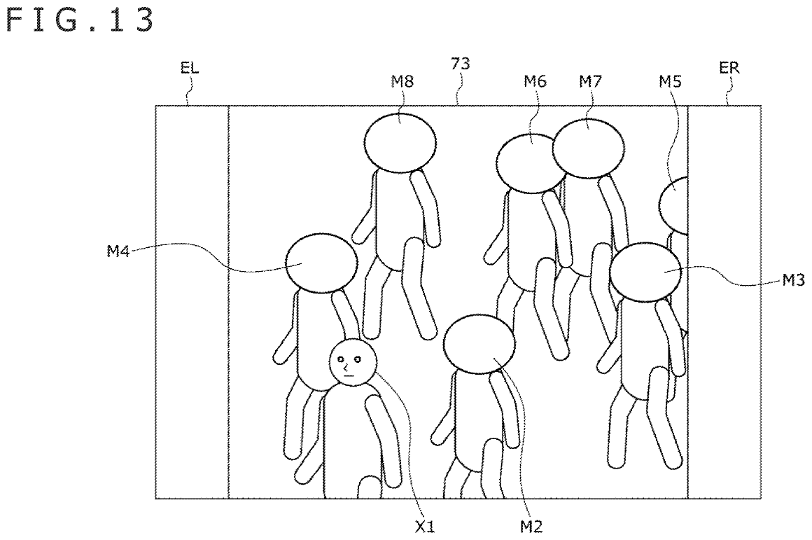

FIG. 13 is a diagram illustrating a target image obtained after subjecting the target image 71 in FIG. 3 to the privacy protection process performed in the second embodiment of the image processing section 24 and is a diagram illustrating the target image obtained after the first masking process is performed by the masking process section 53. It should be noted that the same reference signs are assigned to the portions in FIG. 13 corresponding to those in FIG. 5 and that the description thereof will be omitted.

A target image 73 in FIG. 13 is an image obtained by subjecting the target image 71 in FIG. 3 to the privacy protection process by the image processing section 24. In the target image 71 in FIG. 3, the number of masking targets included in the target image 71 is 8 as illustrated in FIG. 12, and the threshold for process switching is equal to or smaller than 19. In this case, the masking process section 53 performs the first masking process and generates the target image 73 in FIG. 13.

In the target image 73 in FIG. 13, of the persons' faces X1 to X8 set by the masking target detection section 52, the images of the persons' faces X2 to X8 (see FIG. 12) except for the person's face X1 detected by the non-masking target detection section 101 are individually abstracted through superimposition of the masking images M2 to M8 on the respective images by the first masking process of the masking process section 53. The image region of the person's face X1 which is the non-masking target is excluded from the region to be abstracted.

It should be noted that, in a case where the number of masking targets included in the target image is larger than the threshold for process switching as illustrated in FIGS. 6 and 7, the non-masking target detection section 101 does not perform any process, and the target image supplied to the non-masking target detection section 101 from the masking target detection section 52 and information regarding the masking target boundaries are supplied to the masking process section 53 in an as-is state. Then, the target image in whole is abstracted as illustrated in FIG. 8 by the second masking process of the masking process section 53.

Also, in a case where the non-masking target to be excluded from the masking targets is not stored in the non-masking target storage section 102, or in a case where a mode is set to a mode in which the process for excluding the non-masking target from the masking targets is not performed due to an operation mode setting selected by a user's operation or the like, the non-masking target detection section 101 does not perform any process, and the target image supplied to the non-masking target detection section 101 from the masking target detection section 52 and information regarding the masking target boundaries are supplied to the masking process section 53 in an as-is state. In consequence, the privacy protection process similar to that in the first embodiment is performed in this case.

It should be noted that any technique among known ones using a feature quantity extraction algorithm, template matching, a machine learning model, or the like can be used for the non-masking target detection process of the non-masking target detection section 101 as in the masking target detection process. Also, the non-masking target detection process can be performed by DSP arithmetic processing by use of a machine learning model such as a neural network as in the masking target detection process.

### (Processing Procedure in Second Embodiment of Image Processing Section 24)

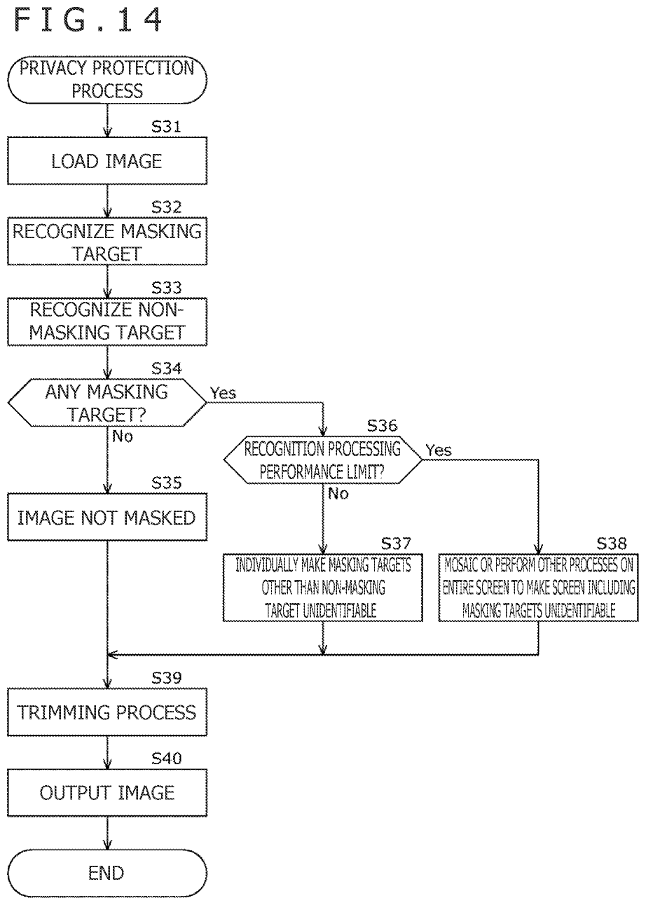

FIG. 14 is a flowchart illustrating a processing procedure of the privacy protection process in the second embodiment of the image processing section 24.

In step S31, the image processing section 24 (image loading section 51) loads a target image to be subjected to the privacy protection process from the storage section 25 (see FIG. 1). The process proceeds from step S31 to step S32.

In step S32, the image processing section 24 (masking target detection section 52) recognizes (detects) masking targets included in the target image loaded in step S31. The process proceeds from step S32 to step S33.

In step S33, the image processing section 24 (non-masking target detection section 101) recognizes a non-masking target included in the target image loaded in step S31. The process proceeds from step S33 to step S34.

In step S34, the image processing section 24 (control section 22) determines whether or not there are any masking targets recognized in step S32 (whether the number of masking targets is 1 or more).

In a case where it is determined in step S34 that there are no recognized masking targets, the process proceeds to step S35, and the image processing section 24 (masking process section 53) does not perform the masking process on the target image. The process proceeds from step S35 to step S39.

In a case where it is determined in step S34 that there are recognized masking targets, the process proceeds to step S36, and the control section 22 determines whether or not the processing load for recognizing (detecting) the masking targets in step S32 has reached the processing performance limit (processing performance limit for recognition). Specifically, the control section 22 determines whether or not the number of masking targets (masking target count) recognized in step S32 is equal to or smaller than 19.

In a case where it is determined in step S36 that the processing performance limit for recognition has yet to be reached (in a case where the number of masking targets is equal to or smaller than 19), the process proceeds to step S37, and the image processing section 24 (masking process section 53) individually abstracts, of the masking targets recognized in step S32, the masking targets other than the non-masking target recognized in step S33 (makes the masking targets unidentifiable) by the first masking process. The process proceeds to step S39.

In a case where it is determined in step S36 that the processing performance limit for recognition has been reached (in a case where the number of masking targets is larger than 19), the process proceeds from step S36 to step S38, and the image processing section 24 (masking process section 53) abstracts the target image in whole loaded in step S31 (makes the target image in whole unidentifiable) by the second masking process through the masking process such as the mosaicing process. The process proceeds from step S38 to step S39.

In step S39, the image processing section 24 (trimming section 54) cuts off, for example, the left edge region or the right edge region from the target image obtained in step S35, step S37, or step S38 by the trimming process. The process proceeds from step S39 to step S40.

In step S40, the image processing section 24 (trimming section 54) outputs, to the storage section 25 (FIG. 1), the target image obtained after the trimming process in step S39 as a target image obtained after the privacy protection process.

According to the above second embodiment of the image processing section 24, switching is made between the first masking process and the second masking process, according to the number of masking targets included in the target image, and the switched process is performed, which makes it possible to speedily and reliably abstract the masking target, regardless of the number of masking targets. Also, of the masking targets, the image of the specific masking target not to be abstracted can be left in the target image without being abstracted. This allows privacy of even a real-time image (still image or video) from a live camera or the like to be reliably protected without substantially any delay.

### <Program>

The above series of processes of the privacy protection process by the image processing section 24 or the like can be performed by hardware or software. In a case where the series of processes are performed by software, a program included in the software is installed to a computer. Here, the computer includes a computer built into dedicated hardware, a computer such as a general-purpose personal computer capable of performing various functions when various programs are installed, and the like.

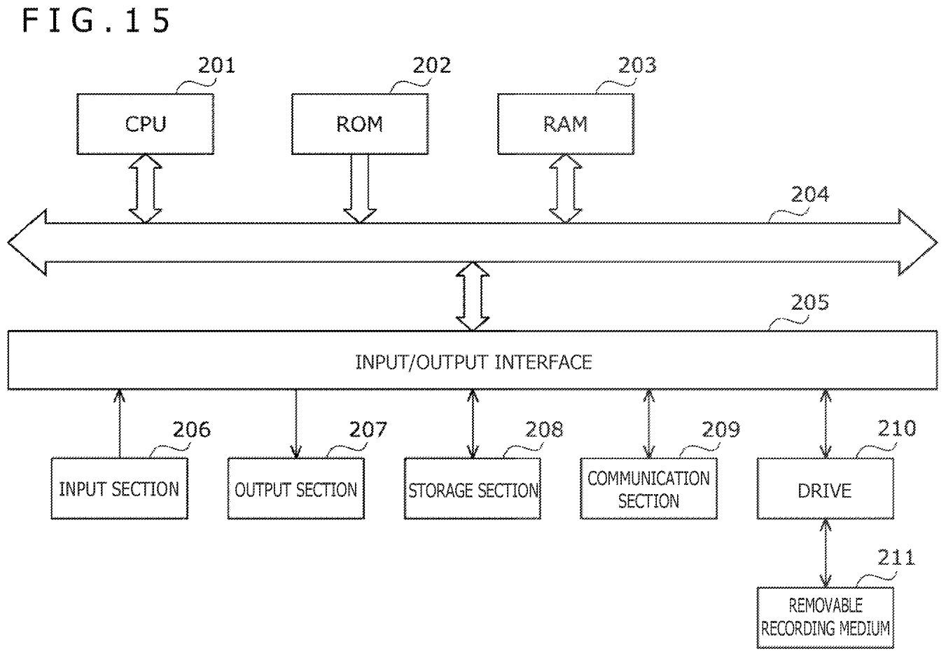

FIG. 15 is a block diagram illustrating a hardware configuration example of a computer that performs the above series of processes by a program.

In the computer, a CPU (Central Processing Unit) 201, a ROM (Read Only Memory) 202, and a RAM (Random Access Memory) 203 are connected to each other by a bus 204.

An input/output interface 205 is further connected to the bus 204. An input section 206, an output section 207, a storage section 208, a communication section 209, and a drive 210 are connected to the input/output interface 205.

The input section 206 includes a keyboard, a mouse, a microphone, and the like. The output section 207 includes a display, a speaker, and the like. The storage section 208 includes a hard disk, a volatile memory, and the like. The communication section 209 includes a network interface and the like. The drive 210 drives a removable medium 211 such as a magnetic disk, an optical disc, a magneto-optical disk, or a semiconductor memory.

In the computer configured as described above, the above series of processes are performed when the CPU 201 loads, for example, a program stored in the storage section 208 into the RAM 203 via the input/output interface 205 and the bus 204 and executes the program.

The program executed by the computer (CPU 201) can be provided in a manner recorded in the removable medium 211 as a package medium or the like. Also, the program can be provided via a wired or wireless transmission medium such as a local area network, the Internet, or digital satellite broadcasting.

In the computer, the program can be installed to the storage section 208 via the input/output interface 205 by inserting the removable medium 211 into the drive 210. Also, the program can be installed to the storage section 208 by receiving the program with the communication section 209 via a wired or wireless transmission medium. In addition, the program can be installed to the ROM 202 and the storage section 208 in advance.

It should be noted that the program executed by the computer may perform the processes chronologically according to a sequence described in the present specification, in parallel, or at such a necessary timing as when the program is called.

The present technology can also have the following configuration.

(1) An information processing apparatus including:

an image processing section adapted to switch, according to the number of abstraction targets that are included in a target image, between a first process that individually abstracts image regions of the abstraction targets in the target image and a second process that abstracts the target image in whole and to perform the switched process.

(2) The information processing apparatus according to (1), in which

the image processing section performs the first process in a case where the number of abstraction targets included in the target image is equal to or smaller than a predetermined threshold, and

the image processing section performs the second process in a case where the number of abstraction targets included in the target image is larger than the predetermined threshold.

(3) The information processing apparatus according to (2), in which

the image processing section has an abstraction target detection section that detects the abstraction targets included in the target image, and

the threshold is a value smaller than a limit count of the abstraction targets that is a count when a processing performance of the abstraction target detection section reaches a limit.

(4) The information processing apparatus according to (3), in which

the threshold is a value smaller only by 1 than the limit count.

(5) The information processing apparatus according to (1), in which

the image processing section performs the first process in a case where the processing load required to detect the abstraction targets in the target image is equal to or smaller than a predetermined threshold, and

the image processing section performs the second process in a case where the processing load is larger than the threshold.

(6) The information processing apparatus according to any one of (1) to (5), in which

the first process abstracts image regions having a predetermined shape including the image regions of the abstraction targets.

(7) The information processing apparatus according to any one of (1) to (6), in which

the first process abstracts the image regions of the abstraction targets by a mosaicing process, a blurring process, a blending process, a superimposition process of a fixed image, or a filling process.

(8) The information processing apparatus according to any one of (1) to (7), in which

the image processing section cuts off or abstracts any one or multiple regions of a left edge region, a right edge region, an upper edge region, and a lower edge region in the target image.

(9) The information processing apparatus according to any one of (1) to (8), in which

the image processing section detects the abstraction targets by a feature quantity extraction algorithm or a neural network.

(10) The information processing apparatus according to any one of (1) to (9), in which

the abstraction targets include at least one of a person's face, a person's body, a person's posture, person's clothing, and a character string.

(11) The information processing apparatus according to any one of (1) to (10), in which

the first process abstracts, of the abstraction targets, the abstraction targets from which a non-abstraction target determined in advance has been excluded.

(12) The information processing apparatus according to (11), in which

the abstraction targets include a specific person's face, specific clothing, and a specific character string.

(13) The information processing apparatus according to any one of (1) to (12), in which

the image processing section is built in an image sensor.

(14) The information processing apparatus according to any one of (1) to (13), in which

the image processing section adds, to an image generated by the first process or the second process, information indicating that the image has been subjected to a privacy protection process.

(15) An information processing method of an information processing apparatus, the information processing apparatus including:

an image processing section, in which

the image processing section switches, according to the number of abstraction targets that are included in a target image, between a first process that individually abstracts image regions of the abstraction targets in the target image and a second process that abstracts the target image in whole and performs the switched process.

(16) A program causing a computer to function as:

an image processing section adapted to switch, according to the number of abstraction targets that are included in a target image, between a first process that individually abstracts image regions of the abstraction targets in the target image and a second process that abstracts the target image in whole and to perform the switched process.

### REFERENCE SIGNS LIST

1: Imaging apparatus

11: Image sensor

12: Application processor

13: Operation section

14: Display section

15: Communication section

21: Imaging section

22: Control section

23: Signal processing section

24: Image processing section

25: Storage section

26: Selection section

51: Image loading section

Masking target detection section

53: Masking process section

54: Trimming section

101: Non-masking target detection section

1. An information processing apparatus comprising:
an image processing section adapted to switch, according to the number of abstraction targets that are included in a target image, between a first process that individually abstracts image regions of the abstraction targets in the target image and a second process that abstracts the target image in whole and to perform the switched process.

2. The information processing apparatus according to claim 1, wherein
the image processing section performs the first process in a case where the number of abstraction targets included in the target image is equal to or smaller than a predetermined threshold, and
the image processing section performs the second process in a case where the number of abstraction targets included in the target image is larger than the predetermined threshold.

3. The information processing apparatus according to claim 2, wherein
the image processing section has an abstraction target detection section that detects the abstraction targets included in the target image, and
the threshold is a value smaller than a limit count of the abstraction targets that is a count when a processing performance of the abstraction target detection section reaches a limit.

4. The information processing apparatus according to claim 3, wherein
the threshold is a value smaller only by 1 than the limit count.

5. The information processing apparatus according to claim 1, wherein
the image processing section performs the first process in a case where the processing load required to detect the abstraction targets in the target image is equal to or smaller than a predetermined threshold, and
the image processing section performs the second process in a case where the processing load is larger than the threshold.

6. The information processing apparatus according to claim 1, wherein
the first process abstracts image regions having a predetermined shape including the image regions of the abstraction targets.

7. The information processing apparatus according to claim 1, wherein
the first process abstracts the image regions of the abstraction targets by a mosaicing process, a blurring process, a blending process, a superimposition process of a fixed image, or a filling process.

8. The information processing apparatus according to claim 1, wherein
the image processing section cuts off or abstracts any one or multiple regions of a left edge region, a right edge region, an upper edge region, and a lower edge region in the target image.

9. The information processing apparatus according to claim 1, wherein
the image processing section detects the abstraction targets by a feature quantity extraction algorithm or a neural network.

10. The information processing apparatus according to claim 1, wherein
the abstraction targets include at least one of a person's face, a person's body, a person's posture, person's clothing, and a character string.

11. The information processing apparatus according to claim 1, wherein
the first process abstracts, of the abstraction targets, the abstraction targets from which a non-abstraction target determined in advance has been excluded.

12. The information processing apparatus according to claim 11, wherein
the abstraction targets include a specific person's face, specific clothing, and a specific character string.

13. The information processing apparatus according to claim 1, wherein
the image processing section is built in an image sensor.

14. The information processing apparatus according to claim 1, wherein
the image processing section adds, to an image generated by the first process or the second process, information indicating that the image has been subjected to a privacy protection process.

15. An information processing method of an information processing apparatus, the information processing apparatus including:
an image processing section, wherein
the image processing section switches, according to the number of abstraction targets that are included in a target image, between a first process that individually abstracts image regions of the abstraction targets in the target image and a second process that abstracts the target image in whole and performs the switched process.

16. A program causing a computer to function as:
an image processing section adapted to switch, according to the number of abstraction targets that are included in a target image, between a first process that individually abstracts image regions of the abstraction targets in the target image and a second process that abstracts the target image in whole and to perform the switched process.
